(19) United States
(12) Patent Application Publication
(10) Pub. No.: US 2024/0400116 A1
(43) Pub. Date: Dec. 5, 2024

(54) RAILWAY VEHICLE WITH AT LEAST ONE DOOR OPENING AND A DOOR CLOSING THE DOOR OPENING, COMPUTER-IMPLEMENTED METHOD FOR MONITORING A DOOR, COMPUTER PROGRAMME PRODUCT AND COMPUTER-READABLE MEDIUM

(71) Applicant: Stadler Rail AG, Bussnang (CH)

(72) Inventors: Daniel FORRER, Bronschhofen (CH); Georg KLUBERTANZ, Altenrhein (CH); Johannes WILHELMER, Lauterach (AT); Martin BOURRELY, St. Gallen (CH)

(73) Assignee: Stadler Rail AG, Bussnang (CH)

(21) Appl. No.: 18/680,020

(22) Filed: May 31, 2024

(30) Foreign Application Priority Data
Jun. 1, 2023 (EP) 23176648.6

(51) Int. Cl. B61D 19/00; B61D 19/02; B61L 15/00; E05F 15/73

(52) U.S. Cl. CPC B61D 19/005; B61L 15/0072; E05F 15/73; B61D 19/02; E05F 2015/767; E05Y 2900/51; E05Y 2900/531

(57) ABSTRACT

The invention relates to a railway vehicle (1) having at least one door opening (2) and a door (3) closing the door opening (2). The railway vehicle (1) comprises a sensor unit (4), a drive and a monitoring computer (8). The rail vehicle (1) can have a control unit (10). The sensor unit (4) can comprise an optical sensor and/or a LiDAR sensor. The sensor unit (4) can scan both the interior (6) of the railway vehicle (1) and the exterior (7) of the railway vehicle (1) in three dimensions. The door (3) can be opened and closed by the drive. The monitoring computer (8) is connected to the sensor unit (4) via a data link. The control unit (10) is connected to the monitoring computer (8) via a data link. The sensor unit (4) can detect at least the presence of passengers in the interior (6) and in the exterior (7), the closing status of the door and the presence of obstacles in the door opening (2).

The invention also relates to a computer-implemented method for monitoring a door (3) in a door opening (2) of a railway vehicle (1), a computer program product and a computer-readable medium.

This application claims priority from European Patent Application Serial No. 23176648.6 filed Jun. 1, 2023.

### FIELD OF THE INVENTION

The present invention relates to a railway vehicle with at least one door opening and a door closing the door opening, a computer-implemented method for monitoring a door, a computer program product and a computer-readable medium.

### BACKGROUND OF THE INVENTION

Railway vehicles with door openings and doors are known from the prior art. Doors are complex and failure-prone components of a railway vehicle. They also fulfil numerous safety-relevant functions. In the state of the art, they are monitored by a large number of different sensors, each of which fulfils a different object. For example, there are already green loops for monitoring the closing status of doors or sensors that detect when an object or a passenger is trapped by the door. In the area of a door in a railway vehicle, there are other objects to fulfil, such as passenger counting, monitoring a sliding step or simply the opening of the door by the passenger.

Numerous sensor arrangements in the area of railway vehicle doors are known from the prior art.

EP 3 194 241 A1 discloses three-dimensional sensing in a contactless manner in a door system in a public transport vehicle. Various sensors for obstacle detection are disclosed.

WO 2022/073702 A1 discloses a method with a sensor to control an actuator of a door depending on a recognised user.

EP 3 135 846 A1 discloses a three-dimensional scanning of a door area with a camera and a control of a door drive and a sliding step.

EP 3 194 240 A1 discloses a three-dimensional scanning of a passenger compartment with a camera and a motion detection as well as a context-based door control.

EP 2 470 407 A1 discloses a camera system that generates stereo images and can recognise obstacles.

DE 10 2014 113 572 A1 discloses a laser scanner for door monitoring.

WO 2016/206917 A1 discloses a detection unit for detecting a parameter of a vehicle as well as a context-based door control and a diagnostic function.

The door monitoring systems known from the prior art have the disadvantage that a large number of sensors are required to ensure the functionality of the door monitoring system. The known door monitoring systems are therefore complex and thus prone to faults.

### SUMMARY OF THE INVENTION

It is the object of the invention to overcome the disadvantages of the prior art and, in particular, to create a rail vehicle with a door monitoring system which is simple in design and can be operated with a minimum of faults.

The object is solved by a railway vehicle with at least one door opening and a door closing the door opening, a computer-implemented method for monitoring a door, a computer program product and a computer-readable medium according to the independent patent claims.

In particular, the object is solved by a railway vehicle having at least one door opening and a door closing the door opening. The railway vehicle comprises a sensor unit, a drive and a monitoring computer. The rail vehicle can have a control unit. The sensor unit can comprise an optical sensor and/or a lidar sensor. The sensor unit can scan both the interior of the rail vehicle and the exterior of the rail vehicle in three dimensions in a contactless manner. The door can be opened and closed by the drive. The monitoring computer is connected to the sensor unit via a data connection. The control unit can be data-connected to the monitoring computer. In particular, the sensor unit can at least detect the presence of passengers in the interior and exterior, the closing status of the door and the presence of obstacles in the door opening.

Such a railway vehicle can be operated reliably and with minimal disruption.

As a railway vehicle suffers at least one delay in the event of a door malfunction and the door is often no longer available for passengers and, in the worst case, the railway vehicle breaks down completely, door malfunctions should occur as rarely as possible. A simpler and more fail-safe system for monitoring door and other functions in the door environment is therefore desirable.

Greater reliability of the door and thus of the rail vehicle can be achieved by implementing as many door and door environment monitoring functions as possible using a sensor system with a reduced number of components instead of various specialised sensors as was previously the case. The sensor unit can comprise just one sensor. The one sensor can be a camera.

When the closing status is detected, the sensor unit can determine that the door is closed and that there is therefore no longer a gap between the door leaves. It is also possible for the locking of the door leaves to be detected alternatively or additionally when the closing status is detected. This can be the mutual interlocking of the door leaves and/or the interlocking of the door leaves with the door frame or another part of the railway vehicle.

It is possible for data to be recorded by the sensor unit when the locking status is detected and for the raw data to be sent from the sensor unit to the monitoring computer. It is possible that the sensor unit comprises a sensor computing unit and that the raw data is at least partially processed by the sensor computing unit and then sent from the sensor computing unit to the monitoring computer. The monitoring computer then further processes the data already processed by the sensor computing unit. It is possible that the sensor computer unit is assigned to a camera of the sensor unit. It is possible that passengers or objects in the detection area are detected by the data from the camera using the sensor computer unit and the data relating to the presence of the passenger or object is sent from the sensor computer unit to the monitoring computer and further processed by the monitoring computer.

It is possible for the mechanical locking of the door leaves to be indicated by a signal that can be detected by the sensor unit. The signal can be detected by a camera of the sensor unit. It is possible for the signal to be generated mechanically.

It is possible that the locking mechanism can be indicated by a mechanical signal when the door is locked, whereby a mechanical locking signal is moved during the locking process with the locking mechanism. When the door is locked, a locking position of the locking signal can be detected by the sensor unit and when the door is unlocked, an unlocking position of the locking signal can be detected by the sensor unit. This ensures that the locking status of the door can be reliably detected. It is possible that several mechanical locking signals can be detected by the sensor unit. This creates redundancy and the locking status of the door can be detected even if a locking signal is contaminated or covered by an object or a passenger. It is possible that the locking signals are provided with a reflector. It is possible that the locking signals are provided with a special detection colour, which is particularly suitable for detection with a camera.

It is possible for the detection signal to be generated electromechanically, for example by an actuator displacing a signal and the signal being detectable by the sensor unit.

It is possible for the railway vehicle to have one sensor unit for each door opening. The rail vehicle then has as many sensor units as there are door openings. Door openings are door openings for passengers in the outer shell of the railway vehicle. Door openings for personnel (driver's cab) or for luggage or for maintenance of the railway vehicle are not necessarily designed with a sensor unit. The interior space of the railway vehicle is the interior space in the area of the respective door opening in which passengers are located or through which passengers who wish to pass through the door opening move. The exterior space of the railway vehicle is the space outside the respective railway vehicle door in which passengers who wish to pass through the respective door opening are located or moving.

A data connection is a connection through which data can be transmitted. The connection can be wired.

The control unit can be arranged in the driver's cab of the railway vehicle. It is also possible for the control unit to be arranged in another area of the railway vehicle, for example if the railway vehicle is an autonomous railway vehicle without a driver's cab.

It is possible for the sensor unit to detect an opening request by a passenger in the interior and/or exterior of the railway vehicle. It is possible for the sensor unit to detect the presence of a passenger and for the monitoring computer to interpret the passenger's presence as a request to open the door. It is possible that the sensor unit interprets a certain gesture by a passenger, for example wiping or holding the passenger's palm at a certain height for a certain period of time, as an opening request.

It is possible for the sensor unit to detect whether an object or part of a passenger's body is trapped between the door leaves.

It is possible for the sensor unit to detect the presence of obstacles or people in the door area. The door area is the area in which the door leaves move.

The sensor unit can be arranged on the inside and/or outside of the railway vehicle. It is possible for the sensor unit to be located centrally on the upper edge of the door opening. In this case, the sensor unit is arranged both on the inside and on the outside of the railway vehicle and the sensor unit can advantageously detect both the interior and the exterior of the railway vehicle.

The sensor unit can comprise an illumination device.

It is possible for the sensor unit to comprise one or more different sensors. The sensor unit can comprise a camera. It is possible that the sensor unit comprises a lidar sensor (based on radar) or a sensor based on beams (e.g. laser). Such sensors emit beams (e.g. radar/laser) and detect the reflection of these beams from objects.

The reflected rays can be used by a computer program to generate a 3D representation of the detected space.

It is possible that the sensor unit comprises several sensors of different types. The measurement results of the different sensors can then be compared and/or superimposed by a computer program and measurement errors can be cancelled out. In addition, it is ensured that the sensor arrangement still provides sufficient results even if one sensor fails.

By arranging several sensors of different types in the sensor unit, the sensor device is reliable and robust and the reliability and operational safety of the entire railway vehicle is guaranteed.

It is possible that a door is blocked by default if a sensor unit or a monitoring computer fails. It is possible for the locking of the door to be indicated to the passengers on a display device.

It is possible that the sensor unit comprises three sensors of different types. The data from the three sensors can then be compared. If the data from one sensor differs from the data from the two other sensors and the two other sensors provide essentially identical data, only the data from the two sensors that provide essentially the same data can be processed. For example, it is possible that the interior and/or exterior of the railway vehicle is scanned by a camera, a lidar sensor and a laser sensor of the sensor unit and the monitoring computer identifies two essentially identical data from the three sensors in terms of information content and processes this data further and sends it to the control unit, for example. It is also possible for the sensor unit to comprise two or three cameras.

The sensor unit can comprise one camera. An image recorded by the camera can be displayed on the control unit, in which case the camera can be integrated into a VSS (Video Surveillance System).

This makes it possible for an image of a door opening and/or a door to be displayed to the train driver. This allows the train driver to open or close the door manually by entering a command into the control unit if the door is blocked by passengers or objects. It is also possible for a loudspeaker device to be arranged on the door and for the train driver to issue instructions to the passengers via the loudspeaker device if the door cannot be operated. It is possible that images recorded by cameras from several sensor units can be displayed on the control unit.

The sensor unit and/or the drive can have only one data connection and/or only one power connection.

Due to the design of the sensor unit, the sensor unit and/or the drive can be significantly simpler than the sensor units and drives known from the prior art. The door can have one door leaf or two door leaves. It can be a swing/sliding door or a sliding door. The door can have one or two leaves.

The sensor unit can detect the presence of a platform, the platform height and the horizontal distance between the platform and the railway vehicle.

This makes it possible to open the door only if there is a platform on the outside of the railway vehicle. By detecting the platform height and the horizontal distance of the platform from the railway vehicle, it is possible to extend a sliding step or a folding step adapted to the respective platform height and the respective distance of the platform from the railway vehicle. This makes the railway vehicle extremely flexible to use and prevents a large gap from developing between the sliding step and the platform, which would pose a danger to the passengers of the railway vehicle.

It is possible for a door to be blocked as long as there is no platform in front of the door. It is possible that the sensor unit can detect whether the railway vehicle is in motion or not. It is also possible that the vertical distance between the platform and a sliding step of the door can be detected.

It is possible that an extendable boarding aid, for example a wheelchair lift, a folding step or a sliding step, is formed in the area of the door.

It is possible for the sensor arrangement to detect whether an access aid, in particular a sliding step of the sliding vehicle, is free of objects and/or passengers. Free means that there are essentially no objects or passengers on the sliding step. The sensor unit can be used to determine the position of the railway vehicle on the platform. It is possible for the platform to be monitored by the sensor unit and for an image signal from the sensor unit to be sent to one or more surveillance monitors. The surveillance monitors can be located inside or outside the railway vehicle.

The sensor unit can be used to count boarding and/or alighting passengers.

It is possible that passengers can be counted by all sensor units of the rail vehicle. The sensor units can send the respective counting result to the monitoring computer. It is possible for the monitoring computer to send the count result to the control unit. In the monitoring computer and/or the control unit, the counting results of the sensor units can be totalled or subtracted. This allows the utilisation of the railway vehicle to be determined. This can prevent the railway vehicle from being overloaded. In addition, data can be collected on the utilisation of the route by railway vehicle passengers. The data can then be used to adjust timetables and improve the services offered to passengers by a rail vehicle company.

It is possible for the monitoring computer to totalise or subtract the counter results of the sensor units and then compare them with a threshold value. If the threshold value is exceeded, it is possible for the monitoring computer to send an overrun signal to the control unit. It is possible for the overshoot signal to be displayed by the control unit. It is possible for the monitoring computer to block the corresponding door when the threshold value is exceeded, so that no further passengers can pass from the exterior of the corresponding door of the railway vehicle into the interior of the corresponding door of the railway vehicle, but passengers can still pass from the interior of the corresponding door of the railway vehicle into the exterior of the corresponding door of the railway vehicle.

It is possible for one or more monitoring computers of a railway vehicle to determine the utilisation of a railway vehicle by adding or subtracting the counts of the sensor units. It is possible for a utilisation signal to be sent from the monitoring computer to the control unit. If a railway vehicle consists of several railway vehicle wagons, it is possible that the capacity utilisation of several railway vehicle wagons is determined as described above and the respective monitoring computers of the respective railway vehicle wagons send the respective capacity utilisation signals to a capacity utilisation computer which is arranged in the railway vehicle. The utilisation computer can be used to compare the utilisation of the individual rail vehicle carriages.

It is possible for the railway vehicle to have display devices, such as monitors, and for the utilisation computer to send the utilisation signals to the display device. This allows passengers to see the utilisation of the rail vehicle carriages in real time and to distribute themselves accordingly in the rail vehicle carriages.

It is possible for the utilisation computer to generate a recommendation signal and send the recommendation signal to the display devices, which display the recommendation signal. The recommendation signal advises the passengers to remain in the area of the railway vehicle in which they are located or advises the passengers to move to another area of the railway vehicle.

The display devices can be visible from the inside and/or outside of the railway vehicle. Passengers in the outside area of the railway vehicle can be directed to a railway vehicle carriage that is less full than the railway vehicle carriage in front of which they are located by a display of a load signal and/or a recommendation signal on the outside of the railway vehicle.

Passengers in the inner area of the railway vehicle can be directed to a railway vehicle carriage which has a lower occupancy rate than the railway vehicle carriage in which they are located by displaying a load signal and/or a recommendation signal on the inside of the railway vehicle.

It is possible that the utilisation computer is connected to a communication device, whereby the communication device is located on or in the railway vehicle. By means of the communication device, the load signal can be sent to a control centre of the rail network and sent by the control centre to a station into which the railway vehicle will enter. In the station, the load signal can then be displayed via display devices. In this way, the passengers waiting at the station are shown the capacity utilisation of the railway vehicle wagons of the approaching railway vehicle. Accordingly, the passengers can arrange themselves on the platform in sectors in which railway vehicles of the approaching railway vehicle will come to a standstill, which have a lower capacity utilisation than other railway vehicles of the approaching railway vehicle.

The sensor unit can be used to determine whether the rail vehicle is in motion.

This allows the door to be locked as long as the rail vehicle is in motion. This ensures that no passengers can leave the railway vehicle while it is in motion.

It is possible for the monitoring computer to use the data from the sensor unit to check whether the railway vehicle is moving and whether there is a platform in front of the door of the railway vehicle. The door is then only unlocked if the railway vehicle is stationary and there is a platform in front of the door of the railway vehicle.

The railway vehicle can have at least two door openings and at least two doors that close the door opening. One sensor unit and one drive can be designed for each door and two sensor units can be connected to the same monitoring computer using data technology. It is possible for two sensor units of opposite doors of the rail vehicle to be connected to the same monitoring computer.

This is advantageous, as usually only the right or left of two opposite doors in the direction of travel needs to be opened. This means that the monitoring computer essentially only needs to have the capacity for one sensor unit. In the case of a railway vehicle or railway vehicle carriage with four doors, two monitoring computers are then arranged.

It is possible for the two monitoring computers to be connected via data technology. If one monitoring computer fails, its function can then be at least partially taken over by the other monitoring computer. This creates redundancy in the monitoring computers and increases the reliability of the door monitoring and the railway vehicle.

It is possible for the monitoring computers to be connected to a train bus. It is also possible that all sensor units are also connected to the train bus.

The monitoring computer can be switched off and started by a signal from the control unit.

This makes it possible to rectify errors in the monitoring computer during operation of the railway vehicle by having the monitoring computer switched off and restarted by a train driver.

The object of the invention is further solved by a computer-implemented method for monitoring a door in a door opening of a railway vehicle as described above. The method comprises the following steps:
Scanning, in a contactless manner, the interior and/or the exterior and in particular the door opening in three dimensions by the sensor unit,
Sending a scanning signal from the sensor unit to the monitoring computer,
Processing of the scanning signal by the monitoring computer into an enabling signal or a blocking signal for the door,
Sending a release signal from the monitoring computer to the control unit if there are no objects or passengers in the door area,
sending a blocking signal and, in particular, an image signal from a camera of the sensor unit to the control unit if there are objects or passengers in the door area,
In particular, displaying the release signal or the blocking signal and in particular the image signal by the control unit.

Such a method can be carried out reliably and has essentially the same advantages as a railway vehicle as described above.

It is possible that the method as described above comprises the following further steps:
Sending the release signal from the monitoring computer to the drive unit if a release signal has been generated by the monitoring computer,
sending the blocking signal from the monitoring computer to the drive unit if a blocking signal has been generated by the monitoring computer.

It is possible that the method as described above comprises the following further steps:
Sending an alarm signal from the monitoring computer to an alarm device if a blocking signal has been generated by the monitoring computer,
Repeated three-dimensional scanning in a contactless manner of the interior and/or exterior and in particular the door opening by the sensor unit,
Sending a release signal from the monitoring computer to the control unit if there are no objects or passengers in the door area,
Sending a blocking signal and in particular an image signal from a camera of the sensor unit to the control unit if there are objects or passengers in the door area.

The alarm device can be, for example, an alarm light, an alarm loudspeaker or an alarm monitor or a combination of these devices. The alarm device indicates to the passengers that there are objects and/or passengers in the door area and that the door should be closed or opened. The activation of the alarm device is therefore a signal to the passengers to leave the door area or to clear the door area. Subsequently, contactless, three-dimensional scanning is used to check again whether there are people or passengers in the door area.

It is possible for one or more of the above-mentioned method steps to be repeated.

The method as described above can include the following further steps:
Detecting the horizontal distance of the platform from the railway vehicle by the sensor unit,
Sending the detected distance from the sensor unit to the monitoring computer,
Determining an exit signal with an exit distance of a sliding step by the monitoring computer,
Sending an extension signal with the extension distance from the monitoring computer to the sliding step.

Such a method allows the sliding step to be extended precisely and prevents gaps from forming between the sliding step and the platform in which passengers could get caught or trip over.

The method as described above can include the following further steps:
Detecting the platform height by the sensor unit,
Sending the detected platform height from the sensor unit to the monitoring computer,
Determining an extension signal with an extension height of the sliding step by the monitoring computer,
Sending the extension signal with the extension height from the monitoring computer to the sliding step.

It is possible for a railway vehicle to stop at a station as described above as follows:

When a railway vehicle enters a stopping station, the train driver issues an opening command via the control unit. This can be done selectively for a single door, a group of doors or for all doors.

The control unit sends the opening command to the monitoring computer.

The monitoring computer causes the sensor unit to detect whether the railway vehicle is stationary. If the railway vehicle is still moving, the sensor unit detects at regular intervals whether the railway vehicle is still moving.

If the standstill is not recognised after a certain time, an error message is sent from the sensor unit to the monitoring computer and the monitoring computer sends the error message to the control unit, where the error message is displayed to the train driver. This can take place after 10 seconds, for example, whereby the sensor unit detects whether the railway vehicle has come to a standstill once per second within 10 seconds of the opening command from the train driver.

If the sensor unit has detected that the railway vehicle has come to a standstill, the sensor unit sends a corresponding signal to the monitoring computer and the monitoring computer causes the sensor unit to detect whether a platform is present.

If the sensor unit has detected a platform, the sensor unit sends a corresponding signal to the monitoring computer and the monitoring computer optionally causes the sensor unit to determine the platform height and distance to the outside of the door. The sensor unit then sends the corresponding signals to the monitoring computer.

It is possible that the sensor unit processes the detected platform data in the sensor computer unit and then sends the data already processed by the sensor computer unit to the monitoring computer, where the transmitted data is processed further. It is possible for the sensor unit to send raw platform data to the monitoring computer.

The monitoring computer causes the sensor unit to check whether the area into which a sliding step is to extend is free of obstacles.

If this is the case, the sensor unit sends corresponding signal to the monitoring computer. The monitoring computer determines the parameters on the basis of which the sliding step should be extended and sends the parameters and the extension command to a drive of the sliding step.

If the sliding step is extended as planned, the sliding step drive sends a confirmation signal to the monitoring computer. The actual door can now be opened. This happens when the sensor unit detects passengers who want to get in or out. Such passengers can be recognised, for example, by the fact that they are standing in front of the door or moving towards it.

It is also possible for the drive to send no confirmation signal to the monitoring computer and for the sensor unit alone to determine whether the sliding step has been extended as planned. In this case, the sliding step can be designed to be simple and therefore fail-safe and robust.

Furthermore, the door area (the space required for the door movement) must be free, which is also checked by the sensor unit and the monitoring computer. If this is the case, the monitoring computer sends an opening command to the door drive unit.

It is possible for the sensor unit to detect the duration of the opening process and/or the noise generated during the opening process and/or vibrations during the opening process. The same is also possible during the closing process. The sensor unit sends the collected data to the monitoring computer. The monitoring computer compares the data received from the sensor unit with certain threshold values. If one of the threshold values is exceeded, the monitoring computer generates a fault signal and sends this to the control unit.

The passengers boarding and alighting are then counted by the sensor unit and the sensor unit sends the count data to the monitoring computer.

When the door is open, the sensor unit detects at regular intervals whether there are still passengers in the area of the door opening who wish to board or alight. If the sensor unit detects that there are no more passengers in the area of the door opening and no more passengers want to get on or off, the sensor unit sends a corresponding signal to the monitoring computer. The monitoring computer then sends a closing command to the door drive unit and the drive unit closes the door.

The monitoring computer triggers the sensor unit to detect the closing process of the door. If the sensor unit detects that the door is completely closed and nothing is jammed, the sensor unit sends a corresponding signal to the monitoring computer and the monitoring computer sends a corresponding signal to the control unit.

For departure, the train driver enters a closing command into the control unit and the control unit sends a corresponding signal to the monitoring computer(s). The monitoring computers check whether the doors are closed. If the doors are closed, the corresponding monitoring computer sends a corresponding signal to the control unit. If a door is not closed, the corresponding monitoring computer initiates a closing process as described above.

The sensor unit checks whether the access aids, in particular the sliding steps, are free, i.e. nobody is standing on them or there is something on them. If the sliding steps are free, the sensor unit sends a corresponding signal to the monitoring computer and the monitoring computer sends a retraction signal to the drive of the sliding step.

The object of the invention is further solved by computer program product. The computer program product comprises instructions which cause the device to carry out the method steps as described above.

The object of the invention is further solved by a computer-readable medium on which the computer program is stored as described above.

### BRIEF DESCRIPTION OF THE DRAWINGS

The invention is explained in more detail in the following figures. It shows:

FIG. 1: A view of a railway vehicle with two doors, sensor units and monitoring computers,

FIG. 2: A view of a railway vehicle with two doors, sensor units, a monitoring computer and a control unit,

FIG. 3: a flowchart of a method for monitoring a door of a railway vehicle,

FIG. 4: a partial cross-section of a railway vehicle with two sensor units and a sliding footboard,

FIG. 5: a top view of a railway vehicle with two connected monitoring computers,

FIG. 6: a top view of a railway vehicle with two connected monitoring computers and sensor units that are connected by data technology.

### DETAILED DESCRIPTION OF THE PREFERRED EMBODIMENTS

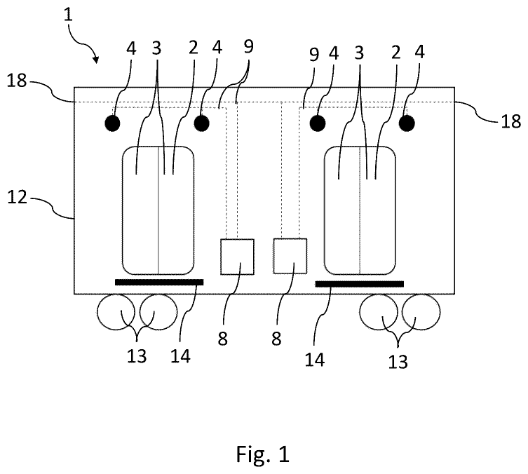

FIG. 1 shows a view of a railway vehicle 1 with a car body 12 and two doors 3. The railway vehicle 1 has four wheels 13. The railway vehicle 1 has two door openings 2 in which the doors 3 are arranged. A sliding step 14 is arranged at each door 3. Two sensor units 4 are arranged in the interior 6 of the vehicle body 12 in the area of each door opening 2. The two sensor units 4 of a door 3 are each connected to a monitoring computer 8 via a data link 9. The two monitoring computers 8 are also connected by a data link 9. The connection 9 extends from the sensor units 4 to the ends 18 of the railway vehicle 1, where they can be connected to a connection (not shown) of another railway vehicle (not shown).

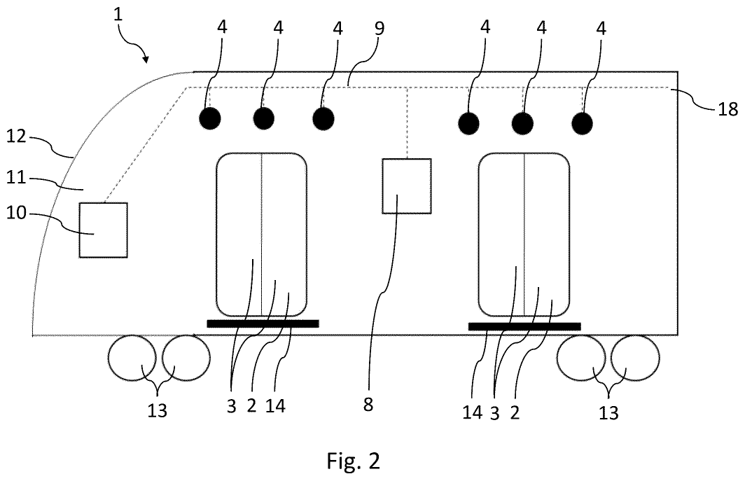

FIG. 2 shows a view of a railway vehicle 1 analogous to FIG. 1. In contrast to FIG. 1, the railway vehicle 1 in FIG. 2 has a driver's cab 11. A control unit 10 is arranged in the driver's cab 11. The control unit 10 is connected to the sensor units 4 and to the monitoring computer 8 via data technology. In FIG. 2, three sensor units 4 are arranged in the interior 6 of the railway vehicle 1, each for one door opening 2.

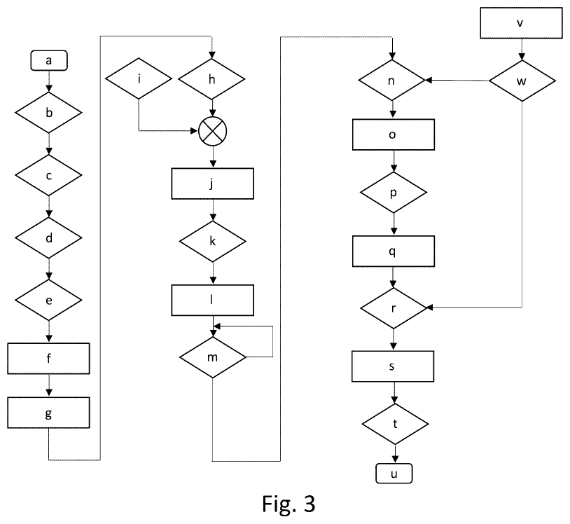

FIG. 3 shows a flowchart of a method for monitoring a door (not shown) of a railway vehicle (not shown). The flow chart comprises the following steps:
a) Opening command locomotive driver
b) Detection of the train movement by the sensor unit
c) Determination by the sensor unit whether a platform is present
d) Determining by the sensor unit whether the height of the platform and the distance of the platform to the railway vehicle are within a parameter
e) Determining by the sensor unit whether the sliding step is free
f) Determining the extension position of the sliding step
g) Extending the sliding step to the determined extension distance
h) Determining whether the door area is free, in particular by the sensor unit
i) Determining, in particular by the sensor unit, whether a passenger is ready to enter or leave the railway vehicle
j) Opening the door
k) Door fully open
l) Counting the passengers boarding and alighting, particular by the sensor unit in
m) Determining, in particular by the sensor unit, whether passengers are still boarding or alighting
n) Determining, in particular by the sensor unit, whether the door area is free
o) Closing the door
p) Door completely closed
q) Exit passenger counting mode
r) Determining, in particular by the sensor unit, whether the sliding step is free
s) Retracting the sliding step
t) Sliding step fully retracted
u) Message from the monitoring computer to the control unit that the train is ready to depart
v) Closing command from the train driver to the control unit
w) Door open?

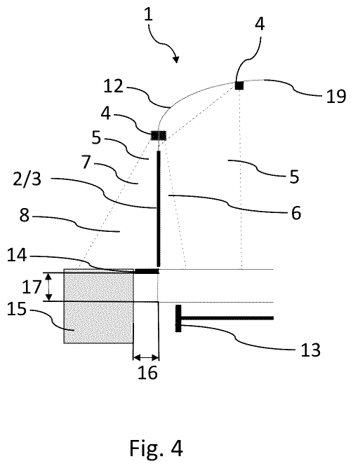

FIG. 4 shows a partial cross-section of a railway vehicle 1 with two sensor units 4 and a sliding step 14. The railway vehicle 1 has a carriage body 12 and a wheel 13. The railway vehicle 1 also has a door opening 2 and a door 3. The platform 15 is arranged in front of the railway vehicle 1. The exterior space 7 is located above the platform 15. The interior space 6 is arranged in the carriage body 12 of the railway vehicle 1. One sensor unit 4 is located in the upper area of the door opening 2. The other sensor unit 4 is arranged in the roof area 19 of the carriage body 12. The two sensor units 4 each have a detection field 5. The detection field 5 of the sensor unit 4 above the door opening 2 overlaps with the interior space 6 and the exterior space 7. The detection field 5 of the sensor unit 4, which is arranged in the roof area 19 of the carriage body 12, overlaps with the interior space 6. The carriage body 12 is arranged at a horizontal distance 16 from the platform 15. The horizontal distance 16 lies within the range of the sensor unit, which is arranged above the door opening 2. The upper edge of the platform 15 is at a vertical distance 17 from the lower edge of the carriage body 12.

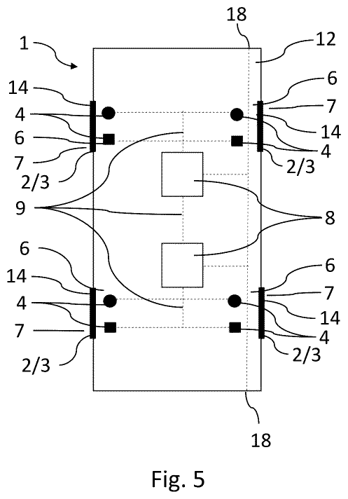

FIG. 5 shows a top view of a railway vehicle 1 with two monitoring computers 8, which are connected by a data link 9. The railway vehicle 1 has a car body 12. The railway vehicle 1 has four door openings 2 and four doors 3. The doors 3 are located in the door openings 2. Two sensor units 4 are arranged at each door opening 2. The sensor units 4 of opposite doors 3 are each connected by a data link 9. In addition, the sensor units 4 of two opposite doors 3 are each connected to a monitoring computer. This means that four sensor units 4 from each of two opposing doors 3 are connected to a monitoring computer 8. A door opening 2 has an outer space 7 in front of the railway vehicle 1 and an inner space 6 in the body 12 of the railway vehicle 1. The railway vehicle 1 has a total of eight sensor units 4 and two monitoring computers 8. The connection 9 extends from the monitoring computers 8 to the ends 18 of the railway vehicle 1, where they can be connected to a connection (not shown) of another railway vehicle (not shown).

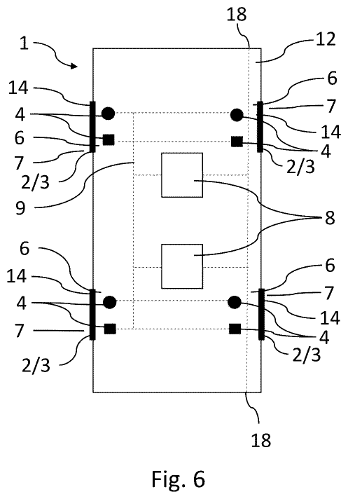

FIG. 6 shows a top view of a railway vehicle 1 with two connected monitoring computers 8 and sensor units 4 analogous to FIG. 5. Unlike in FIG. 5, the sensor units 8 in FIG. 6 are all connected to each other by a data link 9. In addition, all sensor units 4 are connected to the two monitoring computers 8. All sensor units 4 and all monitoring computers 8 of the railway vehicle 1 are thus connected by a network of data connections 9.

1. A railway vehicle comprising:
a door opening and a door configured to close the door opening,
a sensor unit configured to scan in a contactless manner in three dimensions both an interior of the railway vehicle and an exterior of the railway vehicle,
a drive configured to open and close the door,
a monitoring computer which is connected to the sensor unit by a data link,
wherein at least a presence of passengers in the interior of the railway vehicle, a presence of passengers in the exterior of the railway vehicle, a closing state of the door and a presence of obstacles in the door opening can be detected by the sensor unit.

2. The railway vehicle according to claim 1, wherein the sensor unit comprises a camera as an optical sensor, and a control unit is configured to display an image taken by the camera.

3. The railway vehicle according to claim 1, wherein the sensor unit and/or the drive only have a data connection or only a power connection.

4. The railway vehicle according to claim 1, wherein the sensor unit is configured to detect a presence of a platform, a height of the platform, and a horizontal distance from the platform to the railway vehicle.

5. The railway vehicle according to claim 1, wherein the sensor unit is configured to count passengers boarding and exiting the railway vehicle.

6. The railway vehicle according to claim 1, wherein the sensor unit is configured to determine whether the railway vehicle is in motion.

7. The railway vehicle according to claim 1, comprising:
a second door opening and a second door configured to close the second door opening;
a second drive configured to open and close the second door; and
a second sensor unit configured to scan in a contactless manner in three dimensions both the interior of the railway vehicle and the exterior of the railway vehicle, where the sensor unit and the second sensor unit are both connected to the monitoring computer by the data link.

8. The railway vehicle according to claim 1, wherein the control unit is configured to switch off and start the monitoring computer.

9. A computer-implemented method for monitoring a door in a door opening of a railway vehicle, comprising:
scanning an interior of the railway vehicle and an exterior of the railway vehicle in a contactless manner in three dimensions by a sensor unit;
sending a scanning signal from the sensor unit to a monitoring computer;
processing the scanning signal by the monitoring computer to form an enabling signal or a blocking signal for the door;
sending an enabling signal from the monitoring computer to a control unit if there are no objects or passengers in a door area; and
sending a blocking signal to the control unit if there are objects or passengers in the door area.

10. The method according to claim 9, wherein the method comprises:
detecting a horizontal distance from a platform to the railway vehicle by the sensor unit;
transmitting the horizontal distance from the sensor unit to the monitoring computer;
determining an extension signal with an extension distance of a sliding step by the monitoring computer; and
sending the extension signal with the extension distance from the monitoring computer to the sliding step.

11. The method according to claim 9, wherein the method comprises:
detecting a height of the platform by the sensor unit;
transmitting the height of the platform from the sensor unit to the monitoring computer;
determining an extension signal with an extension height of a sliding step by the monitoring computer; and
sending the extension signal with the extension height from the monitoring computer to the sliding step.

12. (canceled)

13. (canceled)

14. The railway vehicle of claim 1 wherein the sensor unit comprises an optical sensor or a lidar sensor.

15. The railway vehicle of claim 1 wherein the data link comprises a control unit that is connected to the monitoring computer by data technology.

16. A computer program product comprising instructions for carrying out the method of claim 9.

17. The computer program product of claim 16 carried out on the monitoring computer of claim 1.

18. A computer readable medium on which the computer program of claim 16 is stored.
